(19) United States
(12) Patent Application Publication
(10) Pub. No.: US 2008/0303784 A1
(43) Pub. Date: Dec. 11, 2008

(54) Information processing apparatus and computer-readable storage medium

(75) Inventors: Takehiko Yamaguchi, Yokohama (JP); Ayumu Akabane, Yokohama (JP); Jun Murayama, Yokohama (JP); Makoto Sato, Yokohama (JP); Satoshi Sakurai, Shinagawa (JP); Takashi Arita, Shinagawa (JP)

Correspondence Address: STAAS & HALSEY LLP, SUITE 700, 1201 NEW YORK AVENUE, N.W., WASHINGTON, DC, 20005, US

(73) Assignees: TOKYO INSTITUTE OF TECHNOLOGY, Kanagawa (JP); FUJITSU COMPONENT LIMITED, Tokyo (JP)

(21) Appl. No.: 11/819,924

(22) Filed: Jun. 29, 2007

(30) Foreign Application Priority Data
Jun. 6, 2007 (JP) 2007-150998

(51) Int. Cl. G09G 5/00

(52) U.S. Cl. 345/156

(57) ABSTRACT

An information processing apparatus includes a control portion and an IF portion. Haptic sense presentation devices are connected to the IF portion. The control portion calculates an area of an image object based on features of the image object and determines the calculated area of the image object as a virtual mass of the image object. The control portion calculates an acceleration of the image object based on the current and previous features of the image object. The control portion calculates a force to be presented to the haptic sense presentation device connected to IF portion based on the virtual mass and the acceleration of the image object and outputs a signal indicative of the calculated force to the haptic sense presentation device.

### BACKGROUND OF THE INVENTION

1. Field of the Invention

The present invention relates to an information processing apparatus connected to a haptic sense presentation device and a computer-readable storage medium.

2. Description of the Related Art

There has heretofore been known a tactile information presentation device capable of generating and presenting a wide variety of tactile information varying with time (for example, see Japanese Patent Application Publication No. 2003-99177).

This tactile information presentation device has a tactile information presentation portion, a source information feature extraction means, a tactile information generation means, and a drive mechanism. The source information feature extraction means is operable to extract time-varying features from time-varying source information (image information or sound information). The tactile information generation means is operable to generate tactile information based on the features of the source information extracted by the source information feature extraction means. The tactile information presentation portion and the drive mechanism are configured to present the tactile information generated by the tactile information generation means.

Furthermore, there has heretofore been known an information processing apparatus capable of presenting tactile information based on color attribute information of an image (for example, see Japanese Patent Application Publication No. 2001-290572).

This information processing apparatus has a tactile sense presentation means, a display information storage means, a tactile information operation means, a control means, an A/D converter, a drive control circuit portion, and a drive means. The tactile information operation means is operable to perform operation based on color attribute information included in display information obtained from the display information storage means and to output a control signal sequentially to the control means in order to present tactile information to an operator. The control means is operable to receive the control signal from the tactile information operation means, calculate a displacement, a vibration frequency, or a control gain to be applied, generate a drive signal based on the calculated results, and output the drive signal to the tactile sense presentation means. When the drive signal is transmitted via the A/D converter and a drive circuit of the drive control circuit portion to the drive means, the tactile sense presentation means is driven to present the tactile information to the operator.

However, the tactile information presentation portion disclosed by Japanese Patent Application Publication No. 2003-99177 can present a force corresponding to time-variations of the source information to a user but cannot present a force simulating an actual physical phenomenon (for example, a force calculated based on a mass and an acceleration).

Similarly, the tactile sense presentation means disclosed by Japanese Patent Application Publication No. 2001-290572 can present a force corresponding to color attribute information included in display information to a user but cannot present a force simulating an actual physical phenomenon (for example, a force calculated based on a mass and an acceleration).

### SUMMARY OF THE INVENTION

It is, therefore, an object of the present invention to provide an information processing apparatus and a computer-readable storage medium capable of presenting a force simulating an actual physical phenomenon to a haptic sense presentation device.

According to a first aspect of the present invention, there is provided an information processing apparatus capable of presenting a force simulating an actual physical phenomenon to a haptic sense presentation device. The information processing apparatus includes connection means for proving connection to a haptic sense presentation device, virtual mass determination means for calculating an area of an image object based on a feature of the image object and determining the calculated area of the image object as a virtual mass of the image object, and acceleration calculation means for calculating an acceleration of the image object based on current and previous features of the image object. The information processing apparatus also includes presentation force calculation means for calculating a force to be presented to the haptic sense presentation device connected to the connection means based on the virtual mass determined by the virtual mass determination means and the acceleration calculated by the acceleration calculation means and output means for outputting a signal indicative of the presentation force calculated by the presentation force calculation means to the haptic sense presentation device.

With the above arrangement, a force to be presented to a haptic sense presentation device is calculated based on a virtual mass and an acceleration of an image object. Accordingly, it is possible to present a force simulating an actual physical phenomenon to the haptic sense presentation device.

Preferably, the acceleration calculation means is operable to calculate a difference of momentums of the image object based on the virtual mass and the current and previous features of the image object. The presentation force calculation means is operable to differentiate the difference of momentums with respect to time to calculate the force to be presented to the haptic sense presentation device.

With the above arrangement, the difference of momentums of the image object is differentiated with respect to time to calculate a force to be presented to the haptic sense presentation device. Accordingly, it is possible to present a force simulating an actual physical phenomenon to the haptic sense presentation device.

Preferably, the virtual mass determination means is operable to calculate an area of a box contacting and surrounding the image object and determine the area of the box as the virtual mass of the image object.

With the above arrangement, it is possible to present a force simulating an actual physical phenomenon to the haptic sense presentation device irrespective of the shape of the image object.

Preferably, the information processing apparatus further includes force correction means for correcting the force calculated by the presentation force calculation means into a force suitable for the haptic sense presentation device connected to the connection means. The output means is operable to output a signal indicative of the force corrected by the force correction means to the haptic sense presentation device.

With the above arrangement, it is possible to prevent a fault of the haptic sense presentation device.

More preferably, the connection means is capable of connection to a plurality of haptic sense presentation devices. The force correction means includes a plurality of filters corresponding to the plurality of haptic sense presentation devices.

With the above arrangement, the presentation force calculated by the presentation force calculation means can be corrected with a filter suitable for the type of the haptic sense presentation device.

Preferably, the virtual mass determination means is operable to calculate an area of the image object based on the feature of the image object, perform a texture analysis on the image object, select a material of the image object, multiply the calculated area of the image object by a specific gravity of the material, and determine the resultant as the virtual mass of the image object.

With the above arrangement, the virtual mass can be calculated in consideration of a material set for the image object.

Preferably, the information processing apparatus further includes color information detection means for detecting color information of the image object and virtual mass correction means for correcting the virtual mass based on the detected color information.

With the above arrangement, because of consideration of the fact that a color of an object has an effect on a weight of the object estimated by a user of the haptic sense presentation device, forces can be transmitted to the user without unpleasantness.

Preferably, the information processing apparatus further includes sound output means for outputting an effective sound at a volume corresponding to a magnitude of the force corrected by the force correction means.

With the above arrangement, the user of the haptic sense presentation device can feel forces and sounds according to movement of the image object.

According to a second aspect of the present invention, there is provided a computer-readable storage medium having a program recorded thereon for providing a computer with functions including connection means for proving connection to a haptic sense presentation device, virtual mass determination means for calculating an area of an image object based on a feature of the image object and determining the calculated area of the image object as a virtual mass of the image object, acceleration calculation means for calculating an acceleration of the image object based on current and previous features of the image object, presentation force calculation means for calculating a force to be presented to the haptic sense presentation device connected to the connection means based on the virtual mass determined by the virtual mass determination means and the acceleration calculated by the acceleration calculation means, and output means for outputting a signal indicative of the force calculated by the presentation force calculation means to the haptic sense presentation device.

With the above arrangement, a force to be presented to a haptic sense presentation device is calculated based on a virtual mass and an acceleration of an image object. Accordingly, it is possible to present a force simulating an actual physical phenomenon to the haptic sense presentation device.

The above and other objects, features, and advantages of the present invention will be apparent from the following description when taken in conjunction with the accompanying drawings that illustrate preferred embodiments of the present invention by way of example.

### BRIEF DESCRIPTION OF THE DRAWINGS

Preferred embodiments of the present invention will be described in detail with reference to the following drawings, wherein:

FIG. 1 is a component diagram showing a haptic sense generation system having an information processing apparatus 1 according to an embodiment of the present invention and a plurality of haptic sense presentation devices 2 and 3;

FIG. 2 is a diagram showing an example of a structure of data stored in a hard disk drive (HDD) in the information processing apparatus shown in FIG. 1;

FIG. 3 is a cross-sectional view of the haptic sense presentation device 2 shown in FIG. 1;

FIG. 4A is an exploded perspective view showing basic components of the haptic sense presentation device 3 shown in FIG.1;

FIG. 4B is an enlarged view of portion B shown in FIG. 4A, showing the details of a panel drive mechanism used in the haptic sense presentation device 3;

FIG. 5 is a flow chart showing an outline of a process performed in the information processing apparatus 1;

FIG. 6 is a flow chart showing the details of a process in Step S1 of FIG. 5;

FIG. 7 is a flow chart showing the details of the process in Step S2 of FIG. 5;

FIG. 8A is a diagram showing a process of converting binary data into XML;

FIG. 8B is a diagram showing a process of associating a bounding box with an executable program;

FIG. 9 is a flow chart showing the details of the process in Step S3 of FIG. 5;

FIG. 10 is a diagram showing an example in which features (object properties) of an object (object n) are extracted and listed at time t;

FIG. 11 is a flow chart showing the details of the process in Step S4 of FIG. 5;

FIG. 12 is a diagram showing an example of a database in the information processing apparatus shown in FIG. 1;

FIG. 13 is a flow chart showing a correction process of a virtual mass which is performed by a control portion of the information processing apparatus shown in FIG. 1; and

FIG. 14 is a graph showing an example of a sigmoid function.

### DESCRIPTION OF THE PREFERRED EMBODIMENTS

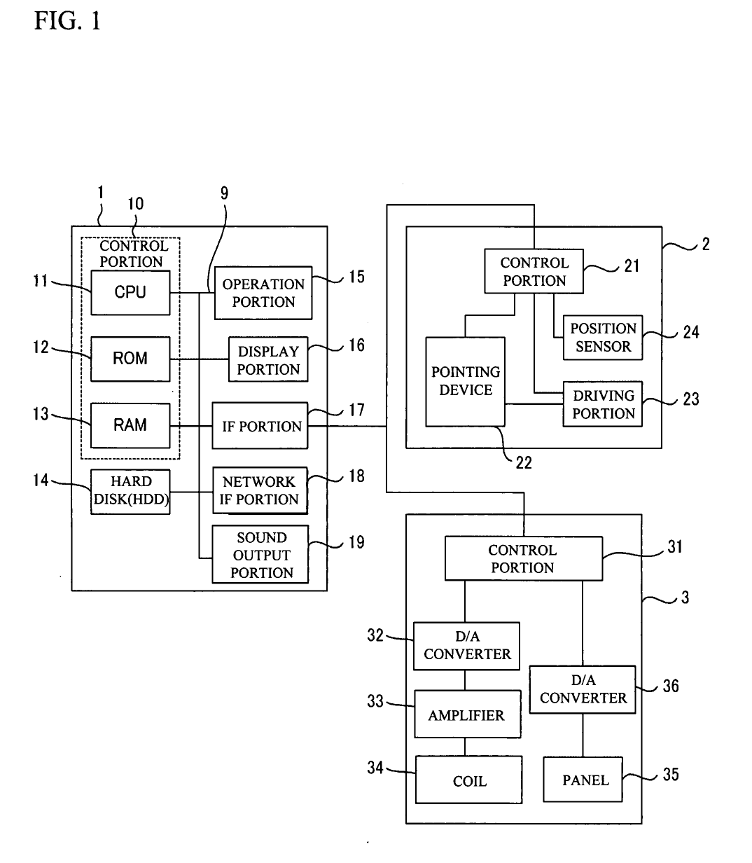

An embodiment of the present invention will be described below with reference to FIGS. 1 to 14.

FIG. 1 is a component diagram showing a haptic sense generation system having the information processing apparatus 1 according to an embodiment of the present invention and a plurality of haptic sense presentation devices 2 and 3.

Generally, a haptic sense presentation device vibrates a certain member based on a signal or data received from an information processing apparatus to thereby present a force to a user, i.e. transmit vibration to a user.

The information processing apparatus 1 is implemented by a computer or the like. In FIG. 1, the information processing apparatus 1 has a CPU 11 operable to control the entire apparatus, a ROM 12 including a control program, a RAM 13 operable to serve as a working area, and a hard disk drive (HDD) 14 including various kinds of information, programs, database, and the like. The information processing apparatus 1 also has an operation portion 15 including a mouse, a keyboard, and the like, a display portion 16 including a liquid crystal display monitor or a CRT, an interface (IF) portion 17 (connection means and output means) for providing connection to the haptic sense presentation devices 2 and 3, a network interface (IF) portion 18, and a sound output portion 19 (sound output means) including a sound processor, a speaker, and the like.

The CPU 11, the ROM 12, and the RAM 13 form a control portion 10 (including virtual mass determination means, acceleration calculation means, presentation force calculation means, output means, force correction means, color information detection means, and virtual mass correction means). The interface (IF) portion 17 is implemented by a serial interface, a USB interface, or the like and connected to the haptic sense presentation devices 2 and 3. The network IF portion 18 is implemented by a network card for connecting the apparatus to a local area network (LAN) or the Internet.

The CPU 11 is connected to the ROM 12, the RAM 13, the hard disk drive (HDD) 14, the operation portion 15, the display portion 16, the IF portion 17, the network IF portion 18, and the sound output portion 19 via a system bus 9.

The haptic sense presentation device 2 has a control portion 21 including a microcomputer or the like for controlling the enter device, a pointing device 22 for commanding movement of a mouse cursor and presenting haptic sense to a user's finger, a driving portion 23 for driving the pointing device 22 based on a haptic sense presentation signal received from the information processing apparatus 1, and a position sensor 24 for detecting a position of the pointing device 22. The control portion 21 may have a circuit portion (not shown) for converting a digital haptic sense presentation signal received from the information processing apparatus 1 into an analog signal and amplifying the converted signal.

The control portion 21 is connected to the pointing device 22, the driving portion 23, and the position sensor 24. Furthermore, the control portion 21 is operable to control the position of the driving portion 23 based on a detection signal from the position sensor 24.

The haptic sense presentation device 3 has a control portion 31 including a microcomputer or the like for controlling the enter device, a D/A converter 32 for converting a digital haptic sense presentation signal received via the control portion 31 from the information processing apparatus 1 into an analog signal, an amplifier 33 for amplifying the digital-to-analog-converted signal, coils 34 for carrying currents based on the amplified signal, a panel 35 capable of vibrating according to the flow of the current and serving as an input device, and an A/D converter 36 for converting analog data inputted by the panel 35 into a digital signal and outputting the converted digital signal.

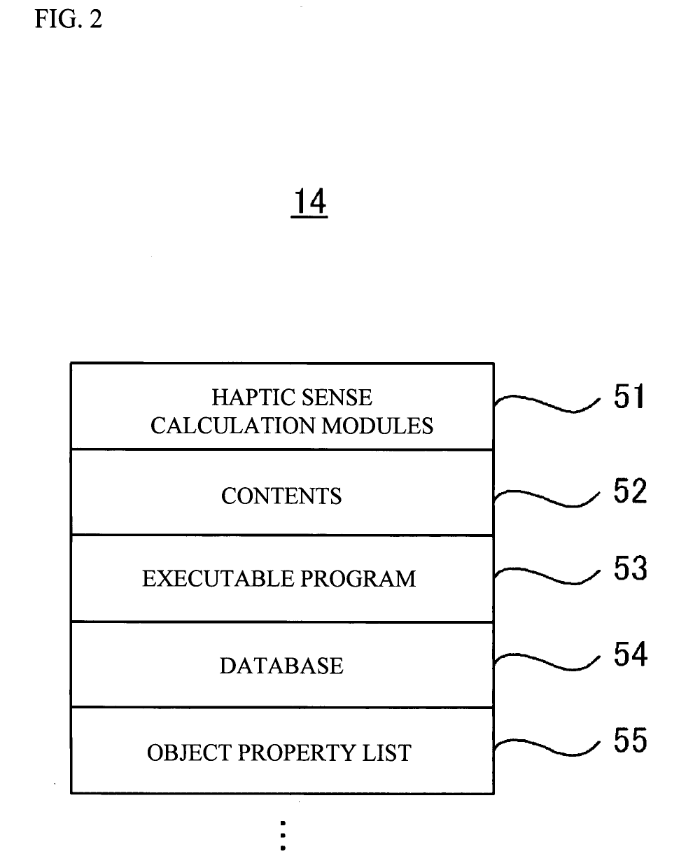

FIG. 2 is a diagram showing an example of a structure of data stored in the HDD 14.

As shown in FIG. 2, the HDD 14 stores a haptic sense calculation modules 51 for calculating a force to be presented to the haptic sense presentation devices, contents 52 such as Flash including sound, image, or video, an executable program 53 for playing back the contents 52, a database 54 (force correction means) including filters to be used according to the types of the haptic sense presentation devices, and an object property list 55, which will be described later. Contents to be used for calculation of a force to be presented to the haptic sense presentation devices are not limited to the contents 52 stored in the HDD 14 and may be any contents on the Internet.

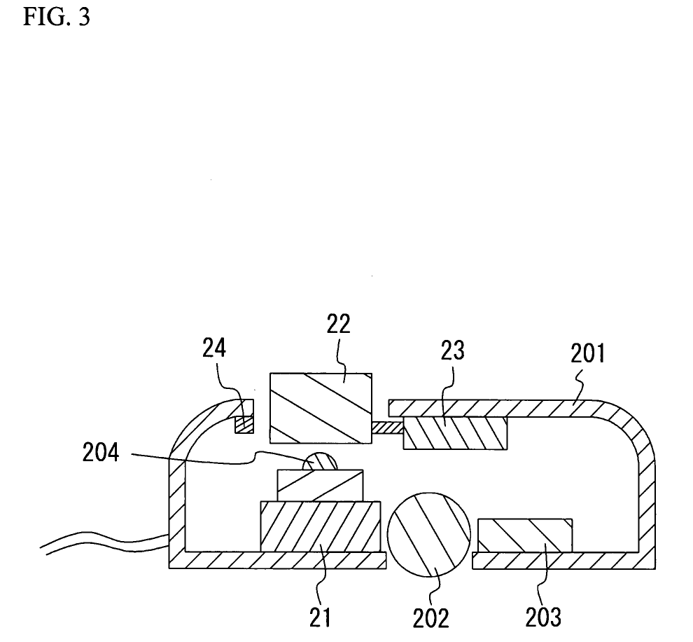

FIG. 3 is a cross-sectional view of the haptic sense presentation device 2.

As shown in FIG. 3, the haptic sense presentation device 2 has a case 201 in the form of a mouse. The driving portion 23 is provided on an upper portion of the case 201. The pointing device 22 is located so that a portion of the pointing device 22 projects from an upper surface of the case 201. The pointing device 22 is connected to the driving portion 23 so that vibration can be transmitted from the driving portion 23 to the pointing device 22. The position sensor 24 is provided on the upper portion of the case 201 so as to face the pointing device 22. The haptic sense presentation device 2 includes a click button 204 located below the pointing device 22. Thus, pressing of the pointing device 22 is transmitted to the click button 204. The control portion 21, a ball 202, and an encoder 203 are provided on a bottom of the case 201. The encoder 203 is operable to convert rotation of the ball 202 into positional information and transmit the positional information to the control portion 21.

Although the control portion 21 is connected to the components other than the ball 202, wires are not illustrated in FIG. 3.

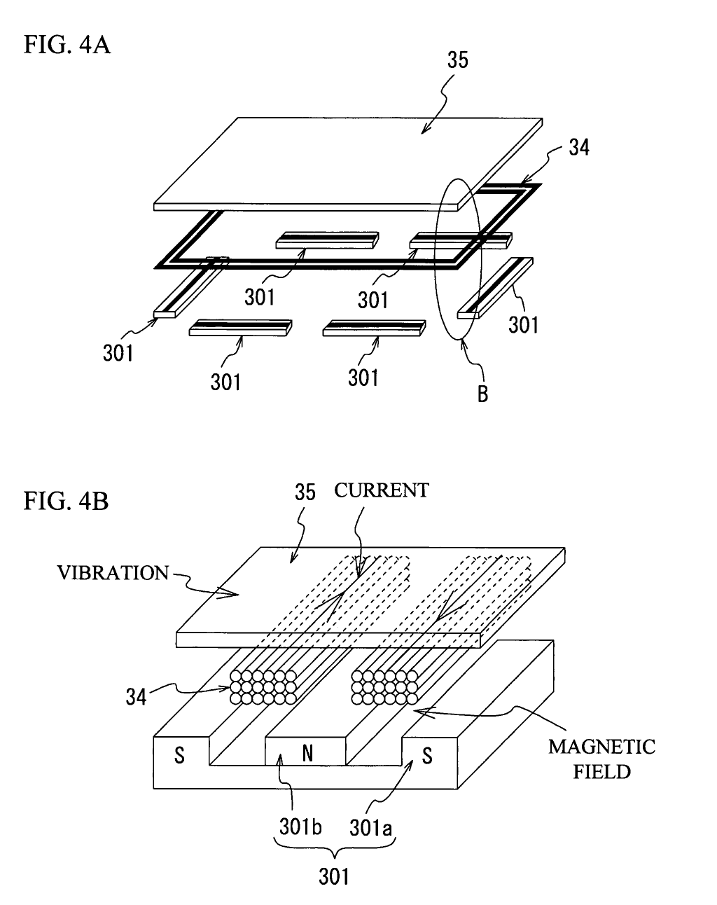

FIG. 4A is an exploded perspective view showing basic components of the haptic sense presentation device 3, and FIG. 4B is an enlarged view of portion B shown in FIG. 4A. FIG. 4B shows the details of a panel drive mechanism used in the haptic sense presentation device 3.

As shown in FIG. 4A, the haptic sense presentation device 3 has the panel 35, coils 34, and a plurality of magnet units 301 including magnets and yokes. The magnet unit 301 is operable to vibrate the panel 35 in a direction perpendicular to a surface of the panel 35 with use of magnetic forces to thereby present tactile sense. The coils 34 are supported on a lower surface of the panel 35 and wound along four sides of the panel 35. As shown in FIG. 4B, the coils 34 are wound so that currents flow through adjacent coils in opposite directions along each side of the panel 35. Each of the magnet units 301 includes a yoke 301a and a magnet 301b. The yoke 301a has an approximately C-shaped cross-section. The magnet 301b is disposed at a central portion of the yoke 301a. The yoke 301a and the magnet 301b are arranged to form a magnetic circuit in which a magnetic flux flows in a clockwise direction and a magnetic circuit in which a magnetic flux flows in a counterclockwise direction. The coils 34 are arranged so that each of currents flowing in two directions crosses the magnetic flux of the corresponding magnetic circuit. In accordance with the Fleming's left-hand rule, forces are applied to the coils 34 by the two magnetic circuits and the currents flowing in the two directions. With the directions of the magnetic poles and the currents illustrated in FIG. 4B, upward forces are generated in the coils 34. These forces vibrate the panel 35.

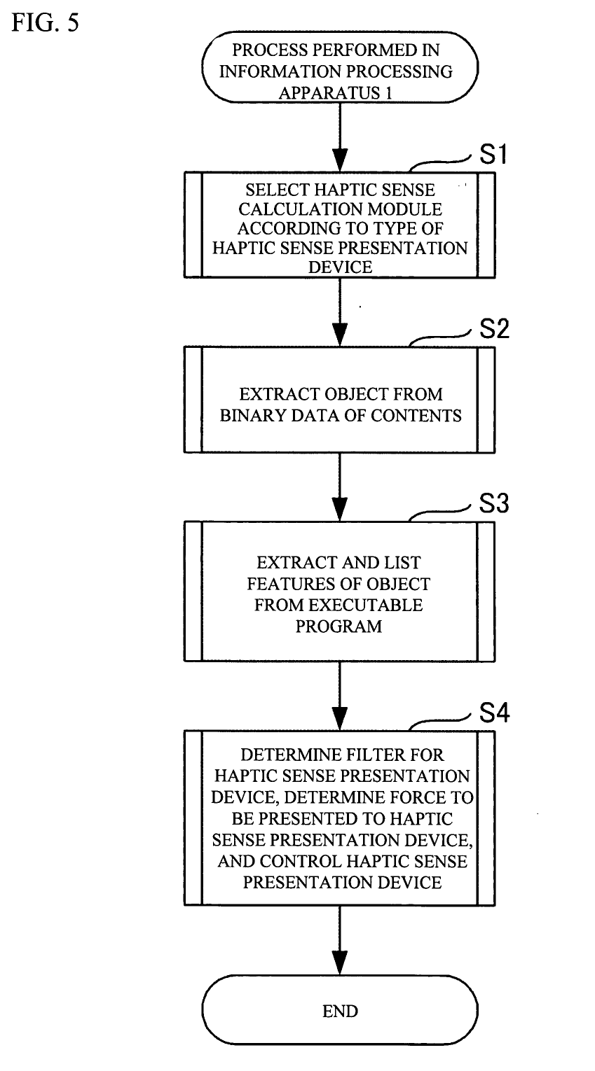

FIG. 5 is a flow chart showing an outline of a process performed in the information processing apparatus 1. The process is performed by the control portion 10. More specifically, the process is performed by the CPU 11 following the control program stored in the ROM 12.

First, when the control portion 10 recognizes a haptic sense presentation device connected to the IF portion 17, it reads the haptic sense calculation module 51 stored in the HDD 14 (Step S1). The control portion 10 executes subsequent steps in accordance with the read haptic sense calculation module 51.

The control portion 10 extracts an object from binary data of the contents 52 stored in the HDD 14 (Step S2). When the contents 52 are played back, the control portion 10 extracts and lists features of the object from the executable program 53 (Step S3).

Then the control portion 10 determines a filter for the haptic sense presentation device based on the type of the haptic sense presentation device, determines a force to be presented to the haptic sense presentation device, and controls the haptic sense presentation device connected to the IF portion 17 (Step S4). Thus, the process is terminated.

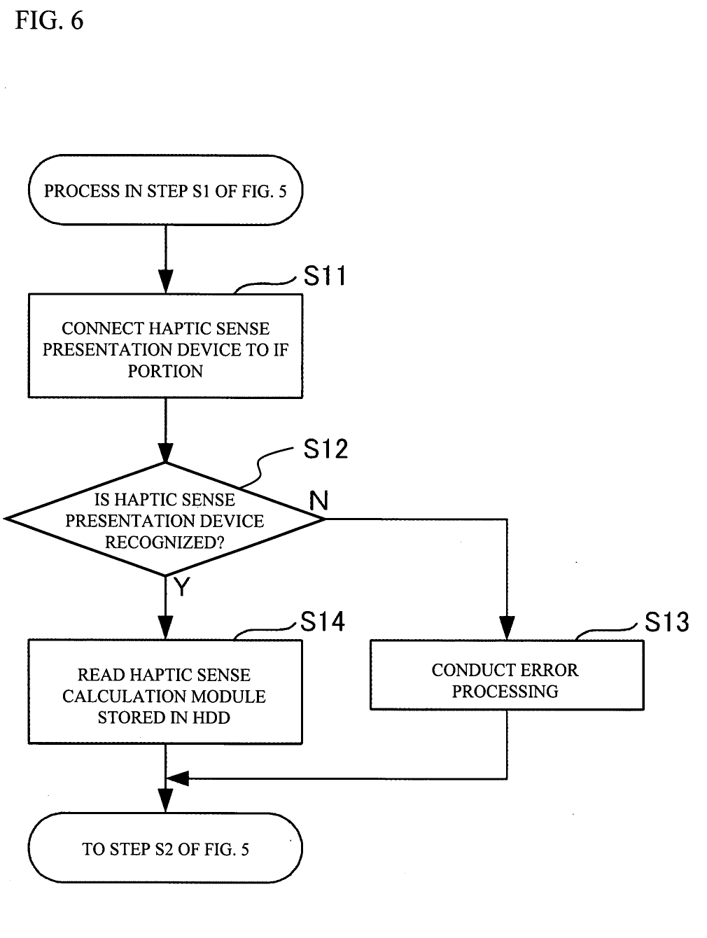

FIG. 6 is a flow chart showing the details of the process in Step S1 of FIG. 5.

First, when a haptic sense presentation device is connected to the IF portion 17 (Step S11), the control portion 10 determines whether or not to recognize the haptic sense presentation device connected to the IF portion 17 (Step S12). In this example, the control portion 10 determines whether or not to recognize the haptic sense presentation device with use of Plug and Play function of an operating system (OS).

If the control portion 10 determines in Step S12 that the haptic sense presentation device cannot be recognized, it conducts error processing (Step S13). Then the process is terminated. On the other hand, if the control portion 10 determines in Step S12 that the haptic sense presentation device can be recognized, it reads the haptic sense calculation module 51 stored in the HDD 14 (Step S14). Then Step 2 of FIG. 5 is performed.

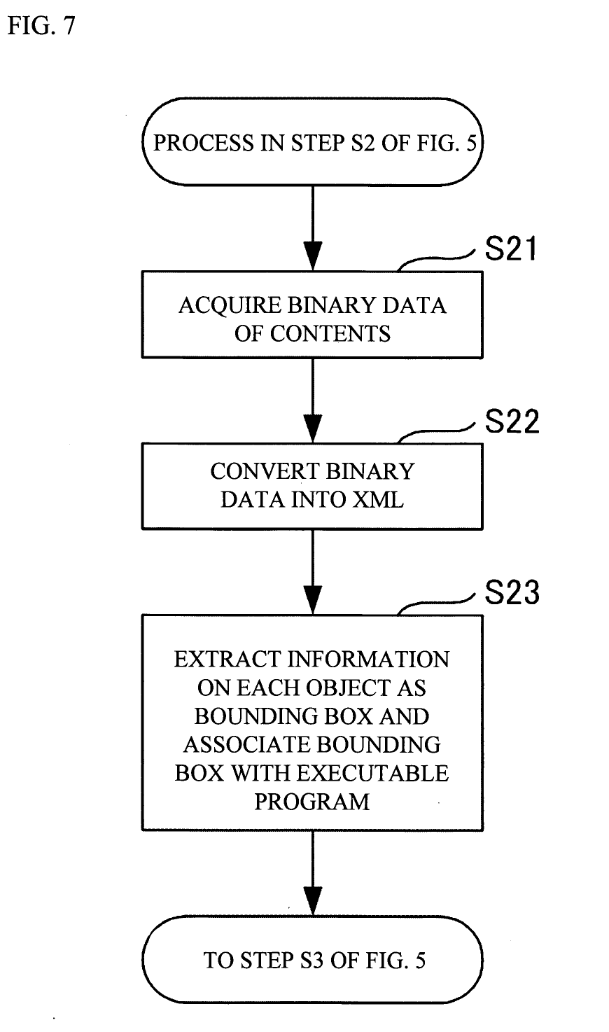

FIG. 7 is a flow chart showing the details of the process in Step S2 of FIG. 5.

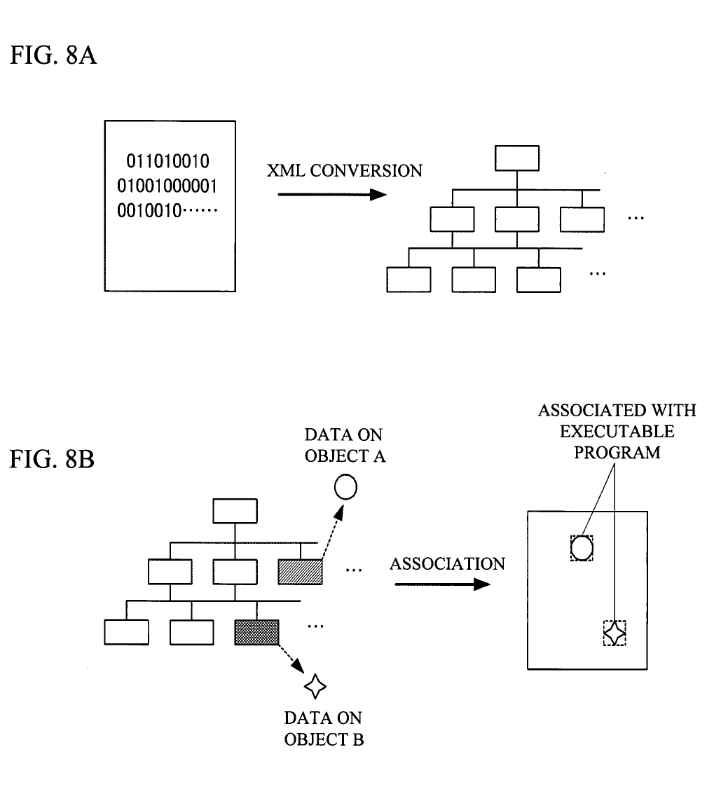

The control portion 10 acquires binary data of the contents 52 stored in the HDD 14 (Step S21) and converts the binary data into extensible markup language (XML) (Step S22). In Steps S21 and S22, focusing on the semi-structure of the binary data as shown in FIG. 8A, the repetition of the binary data is described with use of tags or the like by XML. This allows the control portion 10 to know the structure of the object controlled by the executable program 53. Information on each object is extracted as a bounding box, and the extracted bounding box is associated with the executable program 53 (Step S23). Then Step S3 of FIG. 5 is performed. This state is shown in FIG. 8B. Although the control portion 10 converts the binary data into XML in Step S22, it may convert text data such as hypertext markup language (HTML) or scalable vector graphics (SVG) into XML.

The process in Step S23 allows the control portion 10 to extract features of an object (object properties) from each object when the executable program 53 starts to play back the contents 52.

Furthermore, if the contents 52 stored in the HDD 14 include Flash data, the control portion 10 can acquire information of the position, size, and color of the object by analyzing the file converted into XML in Step S22.

The contents to be used are not limited to the contents 52 stored in the HDD 14 and may be any contents on the Internet.

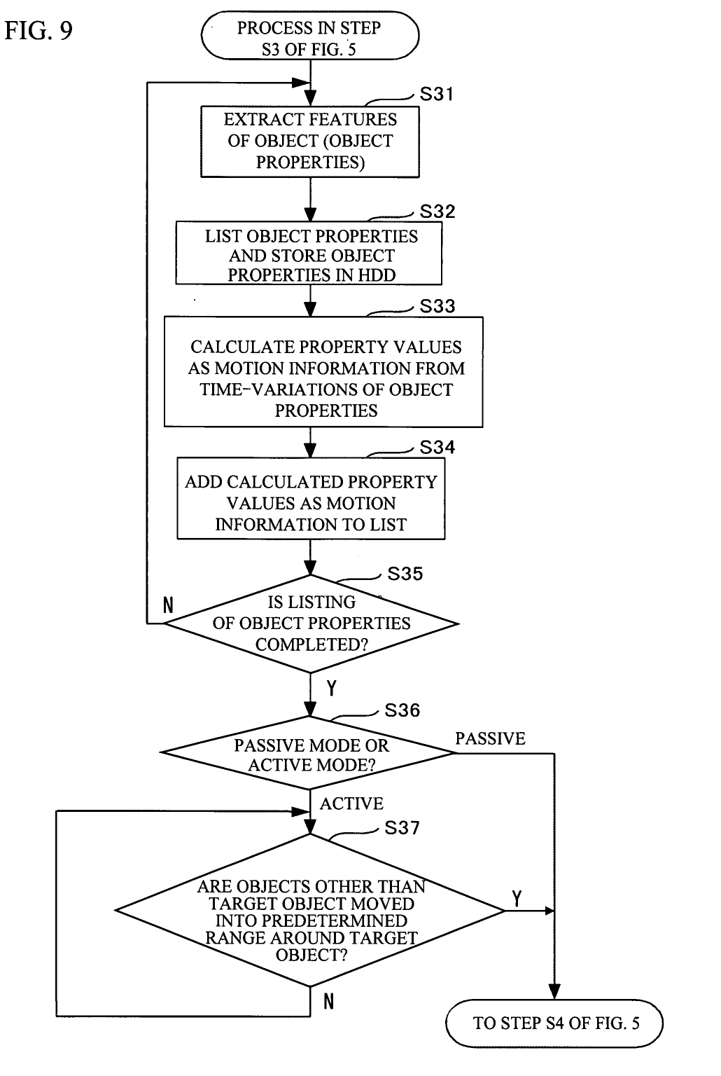

FIG. 9 is a flow chart showing the details of the process in Step S3 of FIG. 5.

When the executable program 53 starts to play back the contents 52, the control portion 10 extracts features of the associated object (object properties) from the executable program 53 (Step S31), lists the extracted object properties, and stores the list in the HDD 14 (Step S32).

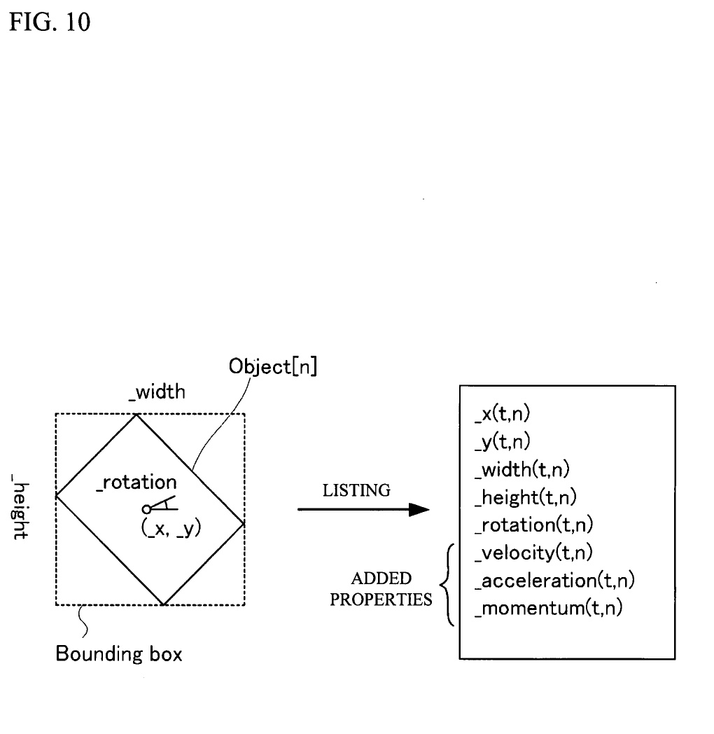

FIG. 10 is a diagram showing an example in which features (object properties) of an object (object n) are extracted and listed at time t.

In FIG. 10, _x(t,n) represents an X coordinate of a barycentric position of the object n, _y(t,n) a Y coordinate of the barycentric position of the object n, _width(t,n) a width of a bounding box surrounding the object n, _height(t,n) a height of the bounding box surrounding the object n, and _rotation(t,n) a rotation angle of the object n.

Referring back to FIG. 9, the control portion 10 calculates property values as motion information from time-variations of the object properties (Step S33) and adds the calculated property values to the list (Step S34).

Property values as motion information including a velocity (_velocity(t,n)), an acceleration (_acceleration(t,n)), and a momentum (_momentum(t,n)) in FIG. 10 are not included in the object (object n). These property values are calculated from property values at the present time t (including an X coordinate of _x(t,n) and a Y coordinate of _y(t,n)) and property values at the past time (the last time) t-1 (including an X coordinate of _x(t-1,n) and a Y coordinate of _y(t-1,n)) by the control portion 10 and added to the list. Here, _x(t,n) may represent X coordinates of all points included in the object n, and _y(t,n) may represent Y coordinates of all points included in the object n. In this case, velocities, accelerations, and momentums of all points included in the object n are calculated.

When the object n is rotated, the control portion 10 calculates an angular velocity, an angular acceleration, and an angular momentum from property values of the center of the object n and a point other than the center of the object n at the present time t and property values of the center of the object n and a point other than the center of the object n at the past time (the last time) t-1.

Subsequently, the control portion 10 determines whether or not listing of object properties has been completed for all the objects associated with the executable program 53 (Step S35). If the control portion 10 determines in Step S35 that the listing has not been completed, then the process is returned to Step S31. In other words, object properties are listed and added to the HDD 14 until the listing of object properties has been completed for all of the objects. Furthermore, property values indicative of motion information are also added to the list. Thus, the list is sequentially updated.

On the other hand, if the control portion 10 determines in Step S35 that the listing has been completed, then the control portion 10 determines which of a passive mode and an active mode is used to operate the pointing device or the panel in the haptic sense presentation devices (Step S36).

Here, the user has set a mode to be used to operate the pointing device or the panel in the haptic sense presentation devices via a user interface (not shown), which was displayed on the display portion 16. In the passive mode, the pointing device or the panel is operated when a target object changes its traveling direction according to progress of time. In the active mode, the pointing device or the panel is operated when objects other than a target object are moved into a predetermined range around the target object.

If the control portion 10 determines in Step S36 that the passive mode is used to operate the pointing device or the panel, then Step S4 of FIG. 5 is performed. On the other hand, if the control portion 10 determines in Step S36 that the active mode is used to operate the pointing device or the panel, then the control portion 10 determines whether or not objects other than a target object are moved into a predetermined range around the target object (Step S37). If the control portion 10 determines in Step S37 that the objects are not moved into the predetermined range around the target object, this determination process is repeated. On the other hand, if the control portion 10 determines in Step S37 that the objects are moved into the predetermined range around the target object, then Step S4 of FIG. 5 is performed.

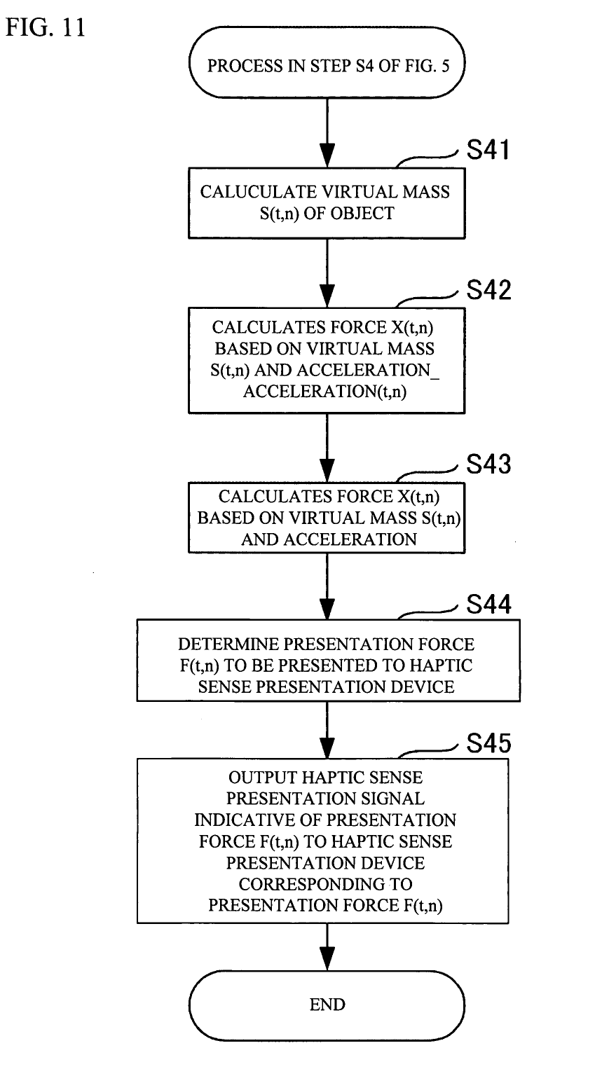

FIG. 11 is a flow chart showing the details of the process in Step S4 of FIG. 5.

First, the control portion 10 calculates a virtual mass S(t,n) with use of the object properties stored in the HDD 14 in accordance with the following formula (1) (Step S41).

Virtual mass: S(t,n)=_width(t,n)·_height(t,n) (1)

In this case, the virtual mass S(t,n) is defined as an area of the bounding box surrounding the object, which is calculated from a width of the bounding box (_width(t,n)) and a height of the bounding box (_height(t,n)). This utilizes human prejudice or psychological features that an object having a larger apparent area should have a larger mass. The calculation method of the virtual mass S(t,n) is not limited to the formula (1). For example, in a case where a rectangular object is inclined as shown in FIG. 10, the control portion 10 may rotate the rectangular object so as to direct one side of the rectangular object toward a horizontal direction or a vertical direction, then calculate an area of the rectangular object, and determine the resultant area as the virtual mass S(t,n). Furthermore, in a case of a circular object, the control portion 10 may calculate an area of the circle and determine the resultant area as the virtual mass S(t,n).

Moreover, the control portion 10 may perform a texture analysis on the object, select a material of the object, and then calculate the virtual mass S(t,n) with use of a physical specific gravity of the material and an area of the bounding box. In this case, the control portion 10 calculates the virtual mass S(t,n) of the object in accordance with the following formula (1-1).

Virtual mass: S(t,n)=_width(t,n)·_height(t,n)·G (1-1)

In the formula (1-1), G is a specific gravity of the selected material.

Thus, the virtual mass can be calculated in consideration of the material set for the object.

Then the control portion 10 calculates a force X(t,n) based on the virtual mass S(t,n) and the acceleration (_acceleration(t,n)) of the object (Step S42). Specifically, the force X(t,n) is calculated in accordance with the following formula (2).

Force: X(t,n)=S(t,n)·_acceleration(t,n) (2)

The force X(t,n) may be calculated by calculating a difference of momentums (_momentum(t,n)) from the virtual mass S(t,n) and two velocities (_velocity(t,n)) and then differentiating the resultant with respect to the time used for calculation of the two velocities.

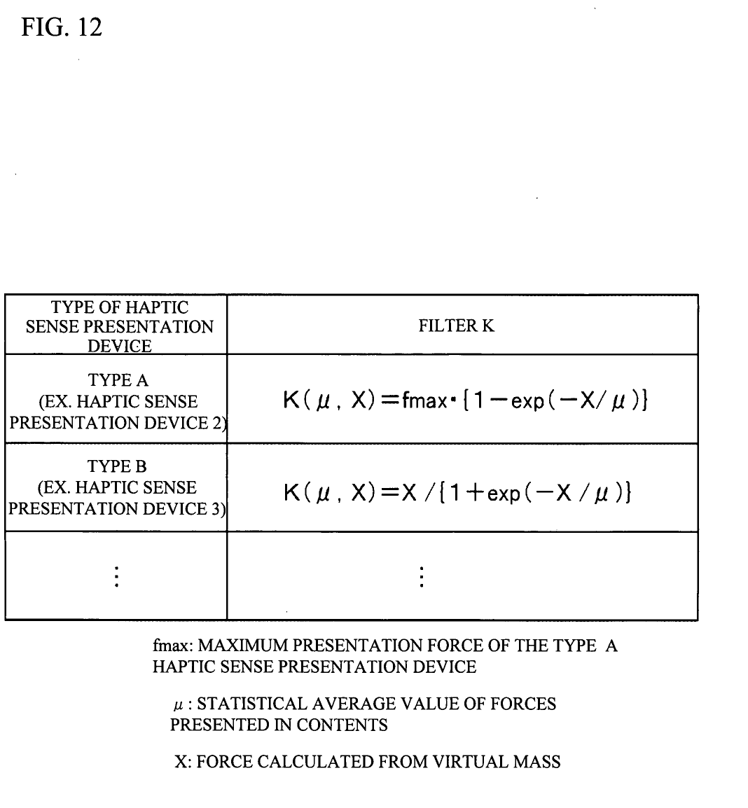

The control portion 10 selects a filter K from the database 54 in the HDD 14 according to the type of the haptic sense presentation device currently connected to the IF portion 17 (Step S43). FIG. 12 shows an example of the database 54. The filters K can limit forces to be presented to the haptic sense presentation devices in order to prevent the haptic sense presentation devices from presenting a force over an allowable limit to a user and thereby causing breakage.

Next, the control portion 10 determines a presentation force F(t,n) to be presented to the haptic sense presentation device (Step S44). In this case, the control portion 10 filters the force X(t,n) with the filter K and uses the resultant as the presentation force F(t,n) to be presented to the haptic sense presentation device. Specifically, the presentation force F(t,n) is determined by the following formula (3).

Presentation force: F(t,n)=K(X(t,n)) (3)

At last, the control portion 10 outputs a haptic sense presentation signal indicative of the presentation force F(t,n) via the IF portion 17 to the haptic sense presentation device corresponding to the presentation force F(t,n) to thereby operate the haptic sense presentation device (Step S45). Thus, the process is terminated.

When a plurality of haptic sense presentation devices connected to the IF portion 17 are to be operated simultaneously, the control portion 10 performs Steps S43 to S45 for each of the haptic sense presentation devices. Thus, the information processing apparatus 1 can simultaneously operate a plurality of haptic sense presentation devices.

The sound output portion 19 may output an effective sound at a volume corresponding to the magnitude of the presentation force determined in Step S44. In this case, the effective sound has previously been set in the sound output portion 19. However, the user can set any effective sound via the operation portion 15. Thus, the user can feel forces and sounds according to movement of objects.

In the above example, the control portion 10 does not consider color information of the object to calculate the virtual mass S(t,n). However, the control portion 10 may correct the virtual mass S(t,n) using color information of the object in consideration of the fact that a color of an object have an effect on a weight of the object estimated by a human.

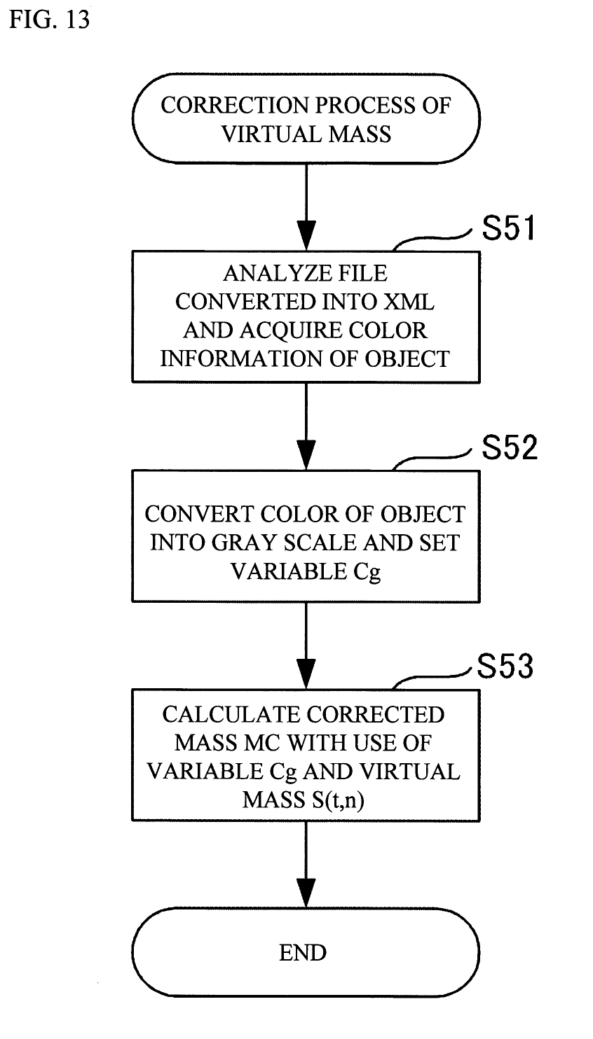

FIG. 13 is a flow chart showing a correction process of the virtual mass, which is performed by the control portion 10.

The control portion 10 analyzes the file converted into XML in Step S22 and acquires color information of the object (Step S51). The control portion 10 converts the color of the object into a gray scale and sets a variable Cg indicative of gradation (Step S52). Then the control portion 10 calculates a corrected mass Mc with use of the variable Cg and the virtual mass S(t,n) (Step S53).

The corrected mass Mc is calculated by the following formula (4).

Corrected mass: Mc=S(t,n)+F(Cg) (4)

The term F(Cg) in the formula (4) represents a sigmoid function given by the following formula (5).

F(Cg)=C1/(1+exp(−(Cg−Cgb))+(C1/2) (5)

In the formula (5), C1 is a maximum value of the sigmoid function, and Cgb is a variable in a range of 0 to 255 in an X-axis of the sigmoid function.

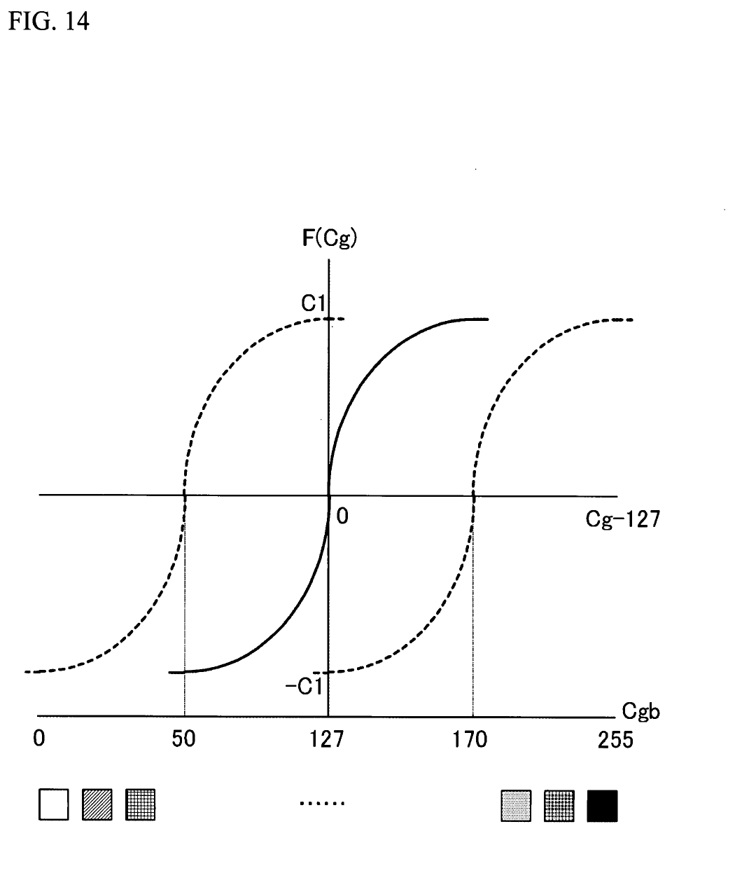

FIG. 14 shows an example of the sigmoid function.

It can be seen from the formulas (4) and (5) that the corrected mass is larger as the object is blacker in the gray scale on the basis of a scale specified by Cgb. As the object is whiter in the gray scale, the corrected mass is smaller.

As described above, according to the above embodiment, the control portion 10 calculates an area of an image object based on the width and height of a bounding box, determines the calculated area of the image object as a virtual mass of the image object (Step S41), calculates an acceleration of the image object based on the current and previous features of the image object (property values indicative of motion information), then calculates a force to be presented to a haptic sense presentation device connected to the IF portion 17 based on the virtual mass and the acceleration of the image object (Step S42), and outputs a signal indicative of the calculated force via the IF portion 17 to the haptic sense presentation device (Step S45).

Thus, a force to be presented to a haptic sense presentation device is calculated based on a virtual mass and an acceleration of an image object. Accordingly, it is possible to present a force simulating an actual physical phenomenon to the haptic sense presentation device.

Furthermore, a force to be presented to the haptic sense presentation device connected to the IF portion 17 is calculated while an area of the image object is used as a virtual mass of the image object. In a case of a constant acceleration, a user of the haptic sense presentation device is likely to think that an object having a larger area should have a larger mass or that an object having a smaller area should have a smaller mass. By using such prejudice or psychological features of a user, forces can be transmitted to the user of the haptic sense presentation device without unpleasantness.

Moreover, the control portion 10 calculates a difference of momentums of an image object based on the virtual mass and the current and previous features of the image object (property values indicative of motion information) and differentiates the difference of momentums with respect to time to obtain a force to be presented to the haptic sense presentation device. Accordingly, it is possible to present a force simulating an actual physical phenomenon to the haptic sense presentation device.

Furthermore, the control portion 10 calculates an area of a bounding box, which contacts and surrounds the image object, and determines the area of the bounding box as a virtual mass of the image object. Accordingly, it is possible to present a force simulating an actual physical phenomenon to the haptic sense presentation device irrespective of the shape of the image object.

Additionally, the control portion 10 corrects the force calculated in Step S42 into a force suitable for the type of the haptic sense presentation device connected to the IF portion 17 with use of a filter K (Steps S43 and S44). Accordingly, the haptic sense presentation device does not output a nonstandard force. As a result, it is possible to prevent a fault of the haptic sense presentation device.

Furthermore, the database 54 includes a plurality of filters corresponding to a plurality of haptic sense presentation devices. Accordingly, the control portion 10 can correct the force to be presented to the haptic sense presentation device with a filter suitable for the type of the haptic sense presentation device.

Moreover, the control portion 10 detects color information of the image object and corrects the virtual mass based on the detected color information. Accordingly, because of consideration of the fact that a color of an object has an effect on a weight of the object estimated by a user of the haptic sense presentation device, forces can be transmitted to the user without unpleasantness.

A software program for implementing the above functions of the information processing apparatus 1 may be recorded in a storage medium. The storage medium may be provided to the information processing apparatus 1. Then the control portion 10 may read and execute the program stored in the storage medium. In such a case, it is also possible to attain the same effects as described in the above embodiment. Examples of the storage medium to provide the program include a CD-ROM, a DVD, and a SD card.

Furthermore, the information processing apparatus 1 can attain the same effects as described in the above embodiment when it executes a software program for implementing the functions of the information processing apparatus 1.

The present invention is not limited to the above embodiment. It should be understood that various changes and modifications may be made without departing from the spirit and scope of the present invention.

The present invention is based on Japanese Patent Application No. 2007-150998 filed on Jun. 6, 2007, the entire disclosure of which is hereby incorporated by reference.

What is claimed is:

1. An information processing apparatus comprising:
connection means for proving connection to a haptic sense presentation device;
virtual mass determination means for calculating an area of an image object based on a feature of the image object and determining the calculated area of the image object as a virtual mass of the image object;
acceleration calculation means for calculating an acceleration of the image object based on current and previous features of the image object;
presentation force calculation means for calculating a force to be presented to the haptic sense presentation device connected to said connection means based on the virtual mass determined by said virtual mass determination means and the acceleration calculated by said acceleration calculation means; and
output means for outputting a signal indicative of the force calculated by said presentation force calculation means to the haptic sense presentation device.

2. The information processing apparatus as recited in claim 1, wherein said acceleration calculation means is operable to calculate a difference of momentums of the image object based on the virtual mass and the current and previous features of the image object,
wherein said presentation force calculation means is operable to differentiate the difference of momentums with respect to time to calculate the force to be presented to the haptic sense presentation device.

3. The information processing apparatus as recited in claim 1, wherein said virtual mass determination means is operable to calculate an area of a box contacting and surrounding the image object and determine the area of the box as the virtual mass of the image object.

4. The information processing apparatus as recited in claim 1, further comprising:
force correction means for correcting the force calculated by said presentation force calculation means into a force suitable for the haptic sense presentation device connected to said connection means,
wherein said output means is operable to output a signal indicative of the force corrected by said force correction means to the haptic sense presentation device.

5. The information processing apparatus as recited in claim 4, wherein said connection means is capable of connection to a plurality of haptic sense presentation devices,
wherein said force correction means includes a plurality of filters corresponding to said plurality of haptic sense presentation devices.

6. The information processing apparatus as recited in claim 1, wherein said virtual mass determination means is operable to calculate an area of the image object based on the feature of the image object, perform a texture analysis on the image object, select a material of the image object, multiply the calculated area of the image object by a specific gravity of the material, and determine the resultant as the virtual mass of the image object.

7. The information processing apparatus as recited in claim 1, further comprising:
color information detection means for detecting color information of the image object; and
virtual mass correction means for correcting the virtual mass based on the detected color information.

8. The information processing apparatus as recited in claim 4, further comprising:
sound output means for outputting an effective sound at a volume corresponding to a magnitude of the force corrected by said force correction means.

9. A computer-readable storage medium having a program recorded thereon for providing a computer with functions including:
connection means for proving connection to a haptic sense presentation device;
virtual mass determination means for calculating an area of an image object based on a feature of the image object and determining the calculated area of the image object as a virtual mass of the image object;
acceleration calculation means for calculating an acceleration of the image object based on current and previous features of the image object;
presentation force calculation means for calculating a force to be presented to the haptic sense presentation device connected to said connection means based on the virtual mass determined by said virtual mass determination means and the acceleration calculated by said acceleration calculation means; and
output means for outputting a signal indicative of the force calculated by said presentation force calculation means to the haptic sense presentation device.
